(19) United States
(12) Patent Application Publication
(10) Pub. No.: US 2003/0209044 A1
(43) Pub. Date: Nov. 13, 2003

(54) Overmolded key assembly with insert and method of making

(76) Inventors: Jeffrey Plate, Brookfield, WI (US); Volker Kemmann, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 10/430,650

(22) Filed: May 6, 2003

Related U.S. Application Data
(60) Provisional application No. 60/378,739, filed on May 7, 2002.

(51) Int. Cl. E05B 19/04

(52) U.S. Cl. 70/408

(57) ABSTRACT

A key assembly for use in a lock. The key assembly includes a key shank having a toe end and a head end. The head end includes a pair of opposed spaced apart legs. An insert is disposed between the spaced apart legs, and has a pair of opposing faces. Material is overmolded onto the key shank head end and at least a portion of the insert. In one embodiment, at least a portion of at least one of the faces is not covered by the material to provide at least one surface for displaying indicia.

### CROSS REFERENCES TO RELATED APPLICATIONS

This application claims the priority benefit of U.S. Provisional Patent Application No. 60/378,739 filed on May 7, 2002.

### STATEMENT REGARDING FEDERALLY SPONSORED RESEARCH

Not Applicable.

### BACKGROUND OF THE INVENTION

The present invention relates to keys for use in vehicles. More particularly, the present invention relates to an overmolded key assembly having an insert.

Keys for use with electronic interlock systems typically include a key shank having a toe end and a head. The toe end is inserted into a mechanical lock. A head formed over the shank head end is grasped by the user to insert and turn the key in the lock. A transponder is typically disposed in the key head end, and electronically interacts with the electronic interlock system to allow the lock to turn.

A known key having a transponder includes a key shank having a toe end and head end. A soft plastic molded over the head end forms the key head. The transponder is embedded in the soft plastic. Unfortunately, the transponder can be damaged during the molding process due to the heat and pressure required to mold the head.

In order to protect the transponder, a carrier can be used, such as disclosed in U.S. Pat. No. 6,035,677. The transponder is inserted into the carrier which is attached to the shank head end. A soft plastic is then molded over the head end and carrier to encapsulate the carrier and form the key head. Although the transponder is protected, the added cost of attaching the carrier to the shank head end increases the cost of the key assembly.

In the above described keys, a logo is typically formed in the soft plastic as the head is formed. As a result, the molds forming the key can be used only for the customer desiring the specific logo. If the customer desires to change the logo, or fails to place further orders, the molds can no longer be used to make keys.

### SUMMARY OF THE INVENTION

The present invention provides a key assembly for a lock. The key assembly includes a key shank having a toe end and a head end. An insert is positioned relative to the head end, and has a pair of opposing faces. Material is overmolded onto the key shank head end and at least a portion of the insert. In one embodiment, at least a portion of at least one of the faces is not covered by the material to provide at least one surface for displaying indicia.

The key assembly is made by forming a key shank having a toe end and a head end. The key shank is positioned in a mold for overmolding material onto at least a portion of the key shank head end. An insert having a pair of opposing faces is positioned in the mold proximal the key shank head end. At least a portion of at least one of the opposing faces of the insert is covered. Material is molded over at least a portion of the head end and insert except at least the covered portion of the at least one of the opposing faces of the insert to provide an exposed surface for displaying indicia.

A general objective of the present invention is to provide a key assembly which can display indicia independent of the key manufacturing process. This objective is accomplished by providing a key assembly including an insert having at least one exposed surface for displaying indicia. Indicia can be formed on the exposed surface prior to making the key, or indicia can be fixed to the surface after the key is made.

Another objective of the present invention is to provide a key assembly which is simple to manufacture. This is accomplished by providing an insert that is not attached to the key shank head end prior to overmolding a material onto the key shank head end. In particular, the insert described herein is fixed relative to the key shank head end by the overmolding material, and is not attached to the key shank head end, as in the prior art.

Another objective of the present invention is to protect a transponder, if provided, during the manufacturing process. This objective is accomplished by providing an insert with a cavity formed therein for receiving the transponder.

These and still other objectives and advantages of the present invention will be apparent from the description which follows. In the detailed description below, preferred embodiments of the invention will be described in reference to the accompanying drawings. These embodiments do not represent the full scope of the invention. Rather the invention may be employed in other embodiments. Reference should therefore be made to the claims herein for interpreting the breadth of the invention.

### BRIEF DESCRIPTION OF THE DRAWINGS

FIG. 1 is a perspective view of a key assembly incorporating the present invention;

FIG. 2 is an exploded perspective view of the key assembly of FIG. 1 without the overmolding material;

FIG. 3 is an edge view of the key assembly of FIG. 1;

FIG. 4 is a sectional view along line 4-4 of FIG. 3;

FIG. 5 is a side view of the key assembly of FIG. 1;

FIG. 6 is a sectional view along line 6-6 of FIG. 5;

FIG. 7 is a sectional view along line 7-7 of FIG. 5;

FIG. 8 is a sectional view of an alternative key assembly incorporating the present invention including a medallion;

FIG. 9 is a sectional plan view of another alternative key assembly incorporating the present invention;

FIG. 10 is a plan view of the key shank of FIG. 9;

FIG. 11 is a bottom view of the insert of FIG. 9; and

FIG. 12 is a side view of the insert of FIG. 9.

### DETAILED DESCRIPTION OF PREFERRED EMBODIMENTS

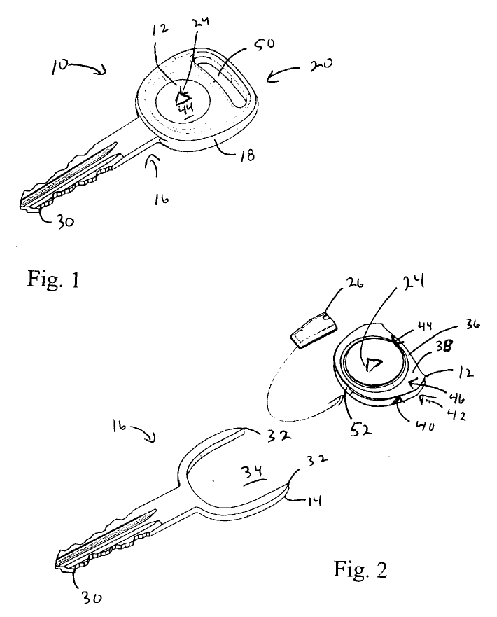

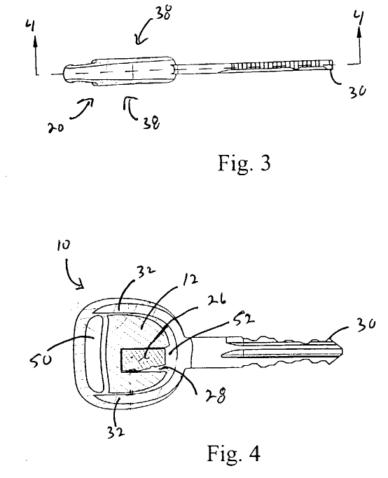

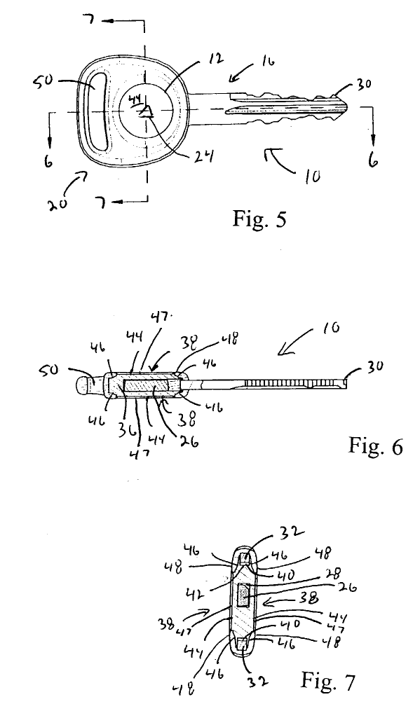

A key assembly 10 shown in FIGS. 1-7 includes an insert 12 embedded into a head end 14 of a key shank 16. Material 18 is overmolded onto the key shank head end 14 and insert 12 to form a key head 20. The insert 12 has a pair of opposing exposed surfaces 22 which are not covered by the overmolding material 18 to provide surfaces for displaying a logo 24 or other indicia. A transponder 26 can be provided which is disposed in a cavity 28 formed in the insert 12. Access to the cavity 28 is cut off by the overmolding material 18 after the transponder 26 is inserted therein.

The key shank 16 is preferably formed from a metallic material, such as nickel plated brass, and has a toe end 30 and the head end 14. The head end 14 is substantially U-shaped, and has a pair of opposed spaced apart legs 32 defining a space 34 therebetween. The toe end 30 can be formed to match the profile specifications of any automobile or lock manufacturer.

The insert 12 is disposed in the space 34 between the head end spaced apart legs 32, and includes a body 36 having a pair of opposing faces 38. Preferably, the insert 12 is molded from engineered resin, such as an acrylonitrile-butadiene-styrene (ABS)+thermoplastic urethane (TPU) blend and the like, having a specified hardness. As best shown in FIG. 7, an outwardly opening groove 40 formed on the insert peripheral edge 42 receives the legs 32 to guide the insert 12 into the space 38 between the head end spaced apart legs 32. Advantageously, the insert 12 can be a carrier for the transponder 26 by forming the cavity 28 in the body 36 between the insert opposing faces 38. Preferably, the cavity 28 has an opening 52 which opens into the peripheral edge 42 of the body 36 for inserting the transponder 26 into the cavity 28.

Each opposing insert face 38 includes an upper surface 44 surrounded by a lower surface 46. The upper surface 44 is spaced above the lower surface 46 to provide a raised surface on which a logo, such an automobile logo, or other indicia can be displayed. The indicia can be molded into the upper surface 44, formed independently of the insert 12 and attached thereto, printed onto the upper surface 44, and the like without departing from the scope of the invention. Advantageously, by providing a separate insert 12 which displays the indicia, the assembly 10 can be provided for a plurality of customers, and only the insert 12 need be changed.

As best shown in FIG. 4, the transponder 26 is inserted into the body cavity 28 through the opening 52. Advantageously, the insert 12 protects the transponder 26 from damage due to pressure from subsequent overmolding or mishandling during the manufacturing process. Although a rectangular transponder 26 is disclosed, the cavity 28 can be formed to receive any shape transponder, such as a transponder having a cylindrical or square shape, or the cavity can be left empty, or not provided at all, without departing from the scope of the present invention.

The key head 20 is formed by overmolding the material 18, such as an ABS+TPU blend over the key shank head end 14 and portions of the insert 12. Preferably, the overmolding material 18 selected is the same material used to form the insert 12 in order to form a strong bond between the insert 12 and overmolding material 18. However, the overmolding material can be any material used in the art, such as a material having a hardness which is less than the insert 12 in order to provide the key with a soft covering, without departing from the scope of the invention. The overmolding material 18 locks the insert 12 relative to the head end spaced apart legs 32 by embedding the insert 12 and legs 32 in the overmolding material 18. A key ring through hole 50 is formed in the key head 20 for storing the key assembly 10 on a key ring. Advantageously, an attachment means is not required to fix the insert relative to the shank head end, thus simplifying the key manufacturing process. Although an attachment means is not required to fix the insert relative to the shank head end, a means for attaching the insert to the shank can be provided without departing from the scope of the invention.

The lower surfaces 46 of the insert faces 38 are covered with the overmolding material 18 to embed the insert 12 in the overmolding material 18. Preferably, the overmolding material 18 overlaps the peripheral edge of the upper surface 44 to form a cavity 47 surrounding indicia displayed by the insert 12. The upper surfaces 44 of the insert 12, however, are preferably, spaced from the outer surface 48 of the overmolding material 18 which surrounds the upper surfaces 44 of the key head 20 to form the cavity 47. Although, providing insert upper surfaces 44 which are spaced from the outer surface 48 of the overmolding material 18 is preferred, the uncovered portion of the insert faces 38 can also be above or flush with the outer surface 48 of the overmolding material 18 and/or the upper surface 44 can be flush or spaced below the lower surface 46 without departing from the scope of the invention.

The key assembly 10 is made by forming the key shank 16 having the toe end 30 and head end 14, using methods known in the art, such as stamping, molding, casting, and the like. The key shank 16 is positioned in a mold for overmolding the material 18 onto the key shank 16 to form the key head 20. The insert 12 is positioned in the mold between the pair of opposed spaced apart legs 32 of the key shank head end 14.

At least a portion of at each insert face upper surface 44 is covered, such as by a part of the mold, a clamp, or other device. The portion of the insert upper surface 44 is covered to prevent the overmolding material 18 from flowing over and covering the upper surfaces 44 of the insert faces 38 and the indicia, if provided, on the upper surfaces 44 prior to applying the overmolding material 18. The overmolding material 18 is, preferably, injected into the mold to form the key head 20 and fix the insert 12 relative to the key shank 16.

Advantageously, upon separating the key assembly 10 from the mold, the portion of the insert faces 39 covered prior to overmolding the material 18 onto the key shank head end 14 provides an exposed surface for displaying the logo or other indicia. Of course, if indicia is not molded onto the exposed surface of the insert or secured to the exposed surface by the overmolding material 18, indicia can be applied to the exposed surface, such as by adhesively attaching molded or printed media, printing directly onto the exposed surface, and the like.

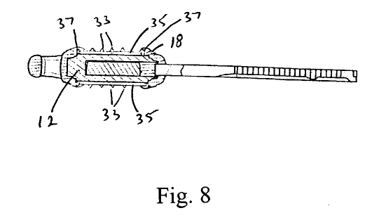

In another embodiment shown in FIG. 8, the indicia 33 is formed on a medallion 35 which covers the upper surface 44. The medallion 35 is secured to the insert by the overmolding material 18 which is overmolded onto a peripheral edge of the medallion 35. Preferably, the insert includes a lip 37 surrounding the upper surface 44 to form a cavity which receives the medallion 35 to prevent the medallion 35 from moving relative to the insert 12 during the molding process. Advantageously, by providing a separate medallion 35 which displays the indicia, the assembly 10 can be provided for a plurality of customers, and only the medallion 35 need be changed.

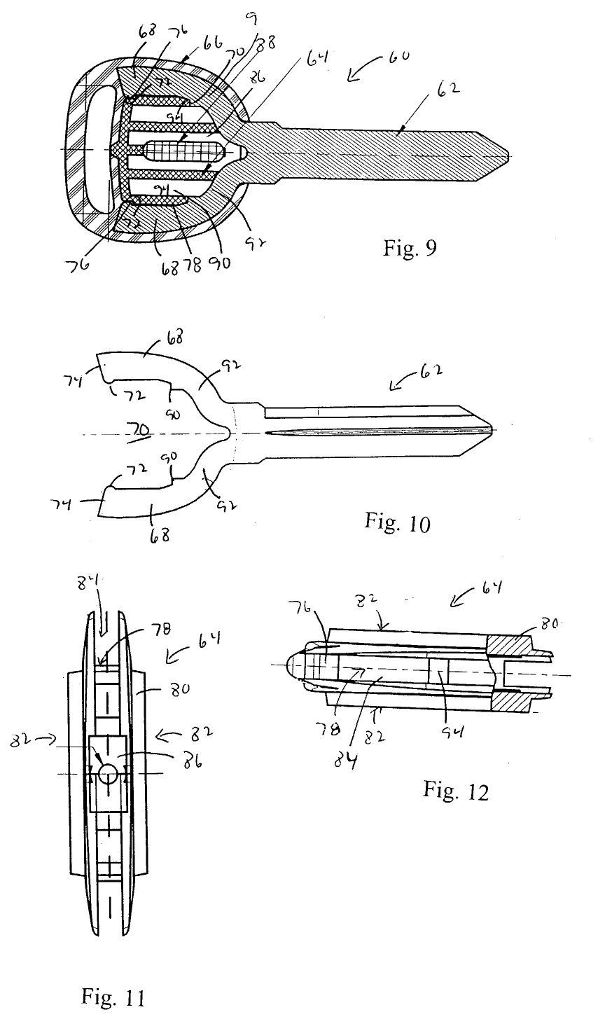

In yet another embodiment disclosed in FIGS. 9-12, a key assembly 60 includes a key shank 62 which positions and retains an insert 64 prior to overmolding material 66 onto the key shank 62 and insert 64. As shown in FIG. 9, the key shank 62 includes a pair of opposed spaced apart legs 68 defining a space 70 therebetween for receiving the insert 64, as described above. Each leg includes a protrusion 72 extending into the space 70.

The protrusion 72 engages the insert 64 to retain the insert 64 in the space 70. Preferably, the protrusion 72 is formed as an integral part of the leg 68, however, the protrusion can be formed as a separate piece joined to the leg without departing from the scope of the invention. Although a single protrusion proximal a distal end 74 of each leg 68 is shown, one or more protrusions can be provided anywhere on only one leg 68 or both legs 68 without departing from the scope of the invention.

The insert 64 is disposed in the space 70 between the legs 68, and includes a body 80 having a pair of opposing faces 82. An outwardly opening groove 84 formed on at least a portion of the a peripheral edge 78 of the insert 64 receives the legs 68 to guide the insert 64 into the space 70. A cavity 86 can be formed in the body 80 between the opposing faces 82 for receiving a transponder 88.

An indent 76 formed in a peripheral edge 78 of the insert 64 receives each of the protrusions to positively retain the insert 64 in the space 70. Advantageously, the indent 76 allows the insert 64 to be snapped into the space 70 between the legs 68 to retain the insert 64 in the space 70 prior to overmolding the material 66 thereon without any additional means for holding the insert 64 in the space 70. This allows the insertion of the insert 64 into the space 70 independent of the overmolding process which overmolds the material 66 onto the key shank 62. Of course, the protrusion can be formed on the insert, and the indent formed in the leg, without departing from the scope of the invention.

The insert 64 is properly oriented within the space 70 between the legs 68 by shoulders 90 extending into the space 70 from the legs 68. Preferably, each shoulder 90 is proximal a proximal end 92 of one of the legs 68, and engages a shelf 94 formed in the peripheral edge 78 of the insert 64. The shelves 94 prevent the insert 64 from rotating about an axis orthogonal to a plane including both legs 68 which could result in indicia formed on the insert 64 from being properly aligned with the key shank 62. Although a pair of shoulders engaging a like number of shelves is disclosed, one or more shoulders can be provided that engage the insert without departing from the scope of the invention.

While there has been shown and described what are at present considered the preferred embodiments of the invention, it will be obvious to those skilled in the art that various changes and modifications can be made therein without departing from the scope of the invention defined by the appended claims. For example, the key assembly can include only one exposed surface for displaying a logo without departing from the scope of the present invention.

We claim:

1. A key assembly for use in a lock, comprising:
a key shank having a toe end and a head end;
an insert disposed proximal said key shank head end, and having a pair of opposing faces; and
material overmolded onto said key shank head end and at least a portion of said insert, wherein at least a portion of at least one of said faces is not covered by said material to provide at least one surface for displaying indicia.

2. The assembly as in claim 1, in which said insert includes a body interposed between said pair of opposing faces, and a cavity is formed in said body between said opposed faces.

3. The assembly as in claim 2, in which a transponder is disposed in said cavity.

4. The assembly as in claim 1, in which indicia is molded onto said at least one surface.

5. The assembly as in claim 1, in which indicia is fixed to said at least one surface.

6. The assembly as in claim 1, in which at least one face of said insert includes a first surface spaced from a second surface, and said overmolding material covers one of said first and second surfaces.

7. The assembly as in claim 6, in which said first surface is raised above said second surface, and said second surface is covered by said overmolding material.

8. The assembly as in claim 6, in which said second surface surrounds said first surface.

9. The assembly as in claim 1, in which said key shank head end includes a pair of opposed spaced apart legs, and said insert is disposed between said pair of opposed spaced apart legs.

10. The assembly as in claim 9, in which at least one protrusion extends from at least one of one of said legs and said insert, and said protrusion engages the other of said insert and said one of one of said legs to retain said insert between said pair of legs.

11. The assembly as in claim 10, in which an indent formed in the other of said insert and said one of one of said legs receives said at least one protrusion to provide a snap fit retaining said insert between said legs.

12. The assembly as in claim 9, in which at least one shoulder extends from at least one of said legs, and said at least one shoulder engages a shelf formed in said insert to orient said insert between said legs.

13. The assembly as in claim 10, in which a groove is formed in a peripheral edge of said insert, and said groove engages said legs to guide said insert between said legs.

14. The assembly as in claim 1, in which a medallion covers said portion not covered by said material, and said material covers a portion of said medallion.

15. A method of making a key assembly for a lock, said method comprising:
forming a key shank having a toe end and a head end;
positioning said key shank in a mold for overmolding material onto at least a portion of said key shank head end;
positioning an insert in said mold proximal said key shank head end, said insert having a pair of opposing faces;
covering at least a portion of at least one of said opposing faces of said insert; and
molding material over at least a portion of said head end and insert except at least said covered portion of said at least one of said opposing faces of said insert to provide an exposed surface for displaying indicia.

16. The method of making a key assembly as in claim 15, in which said insert includes a body defining a cavity interposed between said pair of opposing faces of said insert, and said method includes inserting a transponder into said cavity prior to molding material over said head end and insert.

17. The method of making a key assembly as in claim 15, in which indicia is formed on said covered portion of said at least one of said opposing faces of said insert.

18. The method of making a key assembly as in claim 15, in which indicia is fixed to said covered portion of said at least one of said opposing faces of said insert.

19. The method of making a key assembly as in claim 15, in which said key shank head end includes a pair of opposed spaced apart legs, and said insert is positioned in said mold between said pair of opposed spaced apart legs.

20. The method of making a key assembly as in claim 15, in which covering at least a portion of at least one of said opposing faces of said insert includes covering at least a portion of said at least one of said opposing faces with a medallion containing indicia.

21. The method of making a key assembly as in claim 20, in which material is molded over a portion of said medallion to fix said medallion relative to said insert.

22. The method of making a key assembly as in claim 15, including positioning said insert relative to said key shank, and then simultaneously positioning said key shank and insert in said mold.

23. The method of making a key assembly as in claim 22, in which said insert is positioned relative to said key shank by snap fitting said insert between a pair of spaced apart legs extending from an end of said key shank, wherein at least one of said spaced apart legs includes structure which engages said insert to retain said insert between said legs.

24. A key assembly for use in a lock, comprising:
a key shank having a toe end and a head end;
a pair of opposed spaced apart legs extending from said key shank;
an insert disposed in said space between said pair of spaced apart legs; and
at least one protrusion extending from at least one of one of said legs and said insert, and engaging the other of said one of said legs and said insert to retain said insert in said space.

25. The key assembly as in claim 24, in which said insert includes a pair of opposing faces, and material is overmolded onto said key shank head end and at least a portion of said insert, wherein at least a portion of at least one of said faces is not covered by said material to provide at least one surface for displaying indicia.

26. The assembly as in claim 25, in which said insert includes a body interposed between said pair of opposing faces, and a cavity is formed in said body between said opposed faces.

27. The assembly as in claim 26, in which a transponder is disposed in said cavity.

28. The assembly as in claim 25, in which indicia is molded onto said at least one surface.

29. The assembly as in claim 25, in which indicia is fixed to said at least one surface.

30. The assembly as in claim 25, in which a medallion covers said portion not covered by said material, and said material covers a portion of said medallion.

31. The assembly as in claim 25, in which at least one face of said insert includes a first surface spaced from a second surface, and said overmolding material covers one of said first and second surfaces.

32. The assembly as in claim 31, in which said first surface is raised above said second surface, and said second surface is covered by said overmolding material.

33. The assembly as in claim 31, in which said second surface surrounds said first surface.

34. The assembly as in claim 24, in which an indent formed in the other of said one of one of said legs and said insert receives said at least one protrusion to provide a snap fit retaining said insert between said legs.

35. The assembly as in claim 24, in which at least one shoulder extends from at least one of said legs, and said at least one shoulder engages a shelf formed in said insert to orient said insert between said legs.

36. The assembly as in claim 24, in which a groove is formed in a peripheral edge of said insert, and said groove engages said legs to guide said insert between said legs.
